(19) United States
(12) Patent Application Publication
(10) Pub. No.: US 2011/0100497 A1
(43) Pub. Date: May 5, 2011

(54) PIPE ARRANGEMENT FOR TEMPERATURE CONTROL OF BUILDINGS

(75) Inventor: Jörg Stette, Seevetal (DE)

(73) Assignee: Uponor Innovation Ab, Fristad (SE)

(21) Appl. No.: 12/996,192

(22) PCT Filed: Jun. 2, 2009
(86) PCT No.: PCT/EP2009/056740

§ 371 Date: Jan. 14, 2011

(30) Foreign Application Priority Data
Jun. 7, 2008 (DE) 10 2008 027 346.5

(51) Int. Cl. F24F 3/06; G05D 23/00

(52) U.S. Cl. 138/38; 165/287

(57) ABSTRACT

The invention relates to a pipe arrangement (10) for temperature control of a building, having a single feed pipe (12) and a single return pipe (20), that can be used for operating a concrete core activation during the night and for providing additional cooling power for peak load operation during the day. First and second temperature control circuits (26, 28) branch off from said pipes in a known manner. The direction of flow within the feed end segment (16) of the feed pipe (12) and the return end segment (24) of the return pipe (20) can be reversed by means of a changeover valve (42). Said end segments thus take on a feed or a return function, depending on the flow direction. Check valves (38, 40) within the feed and return end segments (16, 24) ensure that the temperature control medium exiting the currently activated temperature control circuit (26 or 28) does not flow into the corresponding non-activated temperature control circuit (28 or 26).

The invention relates to a pipe arrangement for temperature control of buildings, having a feed pipe, a return pipe, and at least one first and one second temperature control circuit branching off from the feed pipe and opening into the return pipe.

In order to control the temperature of a building, in a modern building the thermal masses of parts of the structure, such as the ceilings, are used. In this context the term concrete core activation is also used. Said systems are very slow to respond, due to their relative large thermal mass, and are not necessarily sufficient to cover peak demands. Therefore, to cover peak loads, additional temperature control elements, that is, heater and/or cooler elements (temperature control elements) are used. While concrete core activation is a temperature control circuit that is embedded in the structure, that is, in the concrete ceiling, the additional temperature control elements are temperature control circuits that are disposed near the surface, such as below the ceiling, similar to sails or the like.

Concrete core activation is currently commonly implemented with a distribution pipe network within the concrete ceiling. If temperature control elements are required in addition to concrete core activation in order to cover peak loads, then a separate distribution pipe network must be provided for this purpose. The temperature control elements for covering peak loads must generally be controlled separately, because the concrete core activation is normally operated at night or is thermally charged, but a peak load element must be in operation just when thermal energy is required during the day. Furthermore, peak load elements are typically also operated at higher power levels, because they rarely cover a large area; rather, they are more likely to be used in edge zones and therefore are installed over a smaller area than the concrete core activation.

Previously, so-called 3 or 4 pipe systems have been used for the above mentioned mixed temperature control systems consisting of concrete core activation and near-surface temperature control elements. Said pipe arrangements comprise separate distribution pipes, but at least separate feed pipes together with a common return pipe. The material costs are, of course, relatively high, because additional distribution pipes (namely for the concrete core activation and the additional temperature control elements) must be laid within the concrete ceiling and additional supply pipes must be provided in central units and shafts, and additional pumps and distribution groups are required.

The object of the invention is to provide a pipe arrangement for temperature control of buildings, in which only a single common feed pipe and a single common return pipe are required, despite having two temperature control circuit systems operated at different times of day.

In order to achieve the object according to the invention, a pipe arrangement for temperature control of buildings is proposed, having
a feed pipe comprising a connection end for connecting to the feed of a temperature control device, and a feed end segment, wherein in a first operating mode, a temperature control medium fed into the connection end flows through the feed pipe to the feed pipe end segment thereof,
a return pipe comprising a connection end for connecting to the return of a temperature control device, and a return end segment, wherein in a first operating mode, a temperature control medium flows from the return end segment of the return pipe through the return pipe, to the connection end thereof,
at least one first temperature control circuit branching off from the feed end segment of the feed pipe and opening into the return end segment of the return pipe, and
at least one second temperature control circuit branching off from the feed end segment of the feed pipe and opening into the return end segment of the return pipe.

In said pipe arrangement, according to the invention, it is provided that
the feed end segment of the feed pipe comprises a first check valve disposed between the branch-off point of the at least one first temperature control circuit and the branch of the at least one second temperature control circuit,
the return end segment of the return pipe comprises a second check valve disposed between the opening point of the at least one first temperature control circuit and the opening point of the at least one second temperature control circuit,
a changeover valve, switchable between a first and a second setting, is disposed between the connection end of the feed pipe and the return end segment of the return pipe and the connection end thereof, comprising a first connection pipe and a second connection pipe,
wherein, in a first operating mode, (i) the first connection pipe is switched to connect between the feed pipe and the feed end segment thereof and (ii) the second connection pipe is switched to connect between the return end segment of the return pipe and the connection end thereof, and
wherein in the second setting of the changeover valve, that is, in the second operating mode, (i) the first connection pipe is switched to connect between the connection end of the feed pipe and the return end segment and (ii) the second connection pipe is switched to connect between the feed end segment and the connection end of the return pipe, and
that when the changeover valve is in the first setting, flow is permissible through the first check valve in the pass-through direction thereof and the second check valve is blocked, and when the changeover valve is in the second setting, the first check valve is blocked and flow is permissible through the second check valve.

The pipe arrangement according to the invention comprises only one feed (feed pipe) and one return (return pipe), like an original 2-pipe system. As a rule, a pump and a distribution group are further provided. The use of only one feed pipe and one return pipe results in lower material costs and a reduced space requirement for laying pipe in shafts and central systems.

The pipe arrangement according to the invention comprises a feed pipe and a return pipe. The feed pipe has a connection end for connecting to the feed of a temperature control device and has a feed end segment. At least one first and at least one second temperature control circuit branch off from the feed end segment. Said two temperature control circuits open into the return end segment of the return pipe, which comprises a connection end for connecting to the return of one temperature control device (heating and/or cooling aggregate), which uses fuel or utilizes geological conditions of thermal energies (geothermal heat, etc.)

According to the invention, the flow direction of the temperature control medium (such as water) within the feed and return end segments is then reversed, wherein, depending on the flow direction, the temperature control medium flows through either the at least one first temperature control circuit or the at least one second temperature control circuit. Two check valves serve this purpose, of which the first is disposed in the feed end segment and the second is disposed in the return end segment. Both check valves are connected between the branch-off points or opening points of the first and second temperature control circuits within the corresponding feed or return end segment. A changeover valve, switchable between two settings, is connected between the connection end of the feed pipe and the feed end segment thereof and between the connection end of the return pipe and the return end segment thereof serves to reverse the flow direction of the temperature control medium within the feed and return end segments. In the first setting, the changeover valve connects the connection end of the feed pipe to the feed end segment thereof and the connection end of the return pipe to the return end segment thereof. In the second setting, however, the changeover valve connects the connection end of the feed pipe to the return end segment of the return pipe, and the connection end of the return pipe to the feed end segment of the feed pipe. The two check valves alternately permit flow through or are blocked in the two settings of the changeover valve, leading to the fact that the temperature control medium always flows through only one of the at least one first temperature control circuit or the at least one second temperature control circuit.

According to the invention, therefore, a common pipe arrangement for temperature control of a building is proposed, having a single feed pipe and a single return pipe, that can be used for operating or for thermally charging a concrete core activation during the night and for providing additional cooling power for peak load operation during the day. First and second temperature control circuits branch off from said pipes in a known manner, and are to be connected to the feed and return end segments using a Tichelmann distribution. The flow direction within the feed end segment of the feed pipe and the return end segment of the return pipe can thus be reversed using a changeover valve. Said end segments thus take on a feed or a return function, depending on the flow direction. Check valves within the feed and return end segment ensure that the temperature control medium leaving the currently activated temperature control circuit does not flow into the corresponding non-activated temperature control circuit.

In an advantageous refinement of the invention, of course, a plurality of first temperature control circuits and a plurality of second temperature control circuits can be provided, wherein the first check valve is disposed within the feed end segment of the feed pipe between the group of branch-off points of the a plurality of first temperature control circuits and the group of branch-off points of the a plurality of second temperature control circuits, and the second check valve is disposed within the return end segment of the return pipe between the group of opening points of the a plurality of first temperature control circuits and the group of opening points of the plurality of second temperature control circuits.

All first and/or second temperature control circuits are expediently disposed according to a Tichelmann distribution between the feed end segment of the feed pipe and the return end segment of the return pipe in order to make the hydraulic conditions more uniform.

The changeover valve that comprises two connection pipes, as described above, can be expediently connected in the pipe arrangement in a simple manner in that the feed pipe (or alternatively the return pipe), that is one of said pipes, comprises a pipe loop, whereby a crossing point is present at which the feed pipe and the return pipe cross each other. In such a configuration, the changeover valve can then be disposed between the connection end of the feed pipe and the crossing point of the feed pipe and return pipe, and between the return end segment of the return pipe and the crossing point of the feed pipe and return pipe.

The invention is described in more detail below, using an embodiment example and referencing the figure. Specifically, shown are:

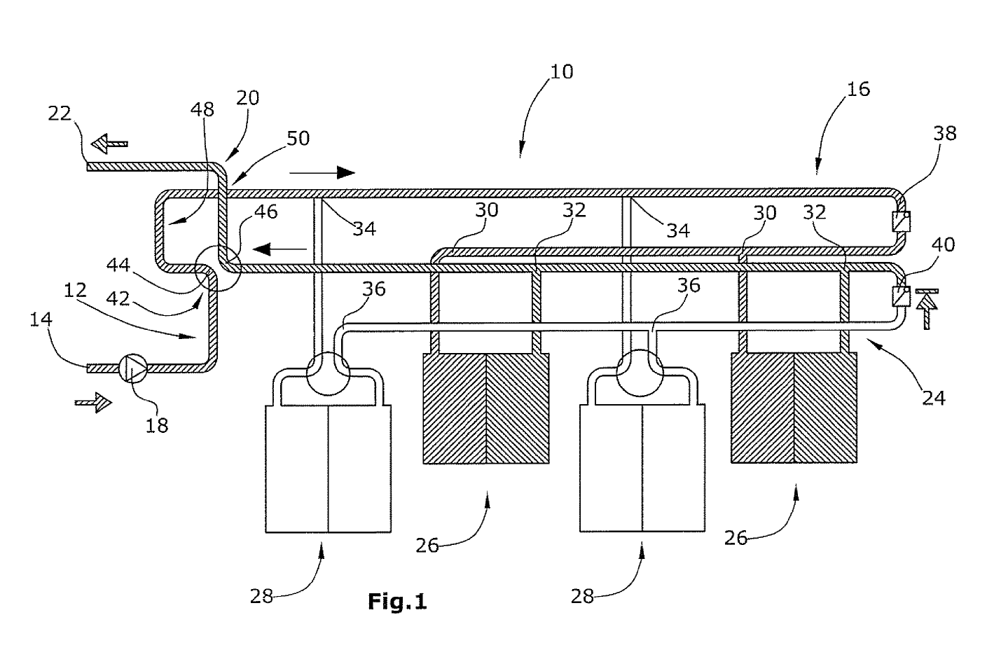

FIG. 1 an embodiment example for a pipeline arrangement for temperature control of buildings in a first operating mode (night operation), in which the concrete core activation is operated or charged, and

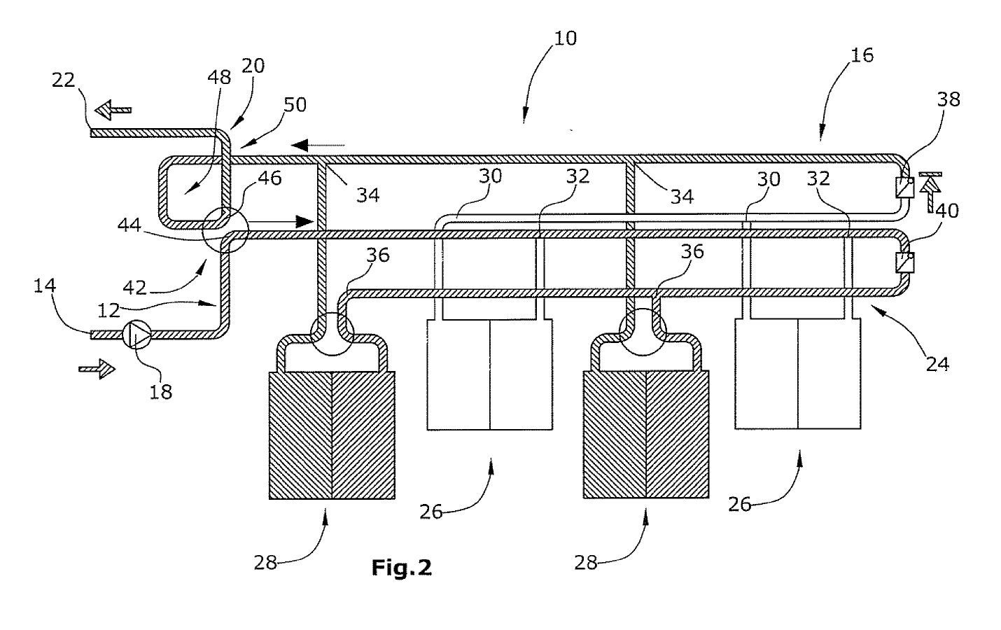

FIG. 2 the pipe arrangement according to FIG. 1 in a second operating mode (day operation), in which the peak load temperature control elements are operated.

According to FIG. 1, the pipe arrangement 10 comprises a feed pipe 12 comprising a connection end 14 for connecting to a temperature control device (such as a cooling aggregate) and a feed end segment 16. A pump 18 can further be disposed in the feed pipe 12.

The pipe system 10 further comprises a return pipe 20 having a connection end 22 for connecting to the return of the temperature control device and a return end segment 24.

As can be seen in FIG. 1, two first temperature control circuits 26 and two second temperature control circuits 28 are connected between the feed end segment 16 and the return end segment 24. The first temperature control circuits 26 thereby branch off at adjacent branch-off points 30 of the feed end segment 16, and open into adjacent opening points 32 in the return end segment 24. The second temperature control circuits 28 thereby branch off also at adjacent branch-off points 34 of the feed end segment 16, and open in turn into adjacent branch-off points 36 in the return end segment 24.

A first check valve 38 is present in the return end segment 16 between the branch-off points 34 and the branch-off points 30 of the same, while a second check valve 40 is present within the return end segment 24 between the two opening points 32 on one side and the two opening points 36 on the other side.

Finally, the pipe arrangement 10 further comprises a changeover valve 42 comprising a first connection pipe 44 and a second connection pipe 46. In the first setting of said changeover valve 42 according to FIG. 1, the first connection pipe 44 connects the connection end 14 of the feed pipe 12 to the feed end segment 16 thereof, while the second connection pipe 46 connects the return end segment 24 of the return pipe 20 to the connection end 22 thereof.

The feed pipe 12 (or alternatively the return pipe 20) comprises a U-shaped pipe segment 48 between the connection end 14 and the feed end segment 16, extending from the changeover valve 42 and crossing the return pipe 20 (or alternatively the feed pipe 12) at a crossing point 50 (see FIG. 1).

In the first operating mode (night operation, for example) according to FIG. 1, the temperature control medium (cool water, for example) flows through the first two temperature control circuits 26. Said temperature control medium flows into the connection end 14 of the feed pipe 12 and enters the feed end segment 16 up to the branch-off points 30 of the two first temperature control circuits 26. The first check valve 38 thus permits flow. After flowing through the two first temperature control circuits 26, the temperature control medium enters the return end segment 24 through the opening points 32. Because in the first operating mode the second check valve 40 prevents flow of the temperature control medium from the opening points 32 to the opening points 36 of the second temperature control circuits 28, the temperature control medium flows from the return end segment 24 to the connection end 22 of the return pipe 20.

Thus in the first operating mode flow is possible through only the first temperature control circuits 26. Said first temperature control circuits are, for example, the temperature control circuits for the concrete core activation that is operated during the night.

In day mode (see FIG. 2—second operating mode), the rooms are then cooled by the cooled concrete ceilings. If the cooling power is not sufficient, then additional cooling power can then be provided in day mode for covering the peak load, by the flow of cool temperature control medium through the second temperature control circuits 28. Cooling medium flowing through the first temperature control circuits 26 during the day is less efficient, because the first temperature control circuits 26 are located in the interior of the concrete ceilings for the concrete core activation, whereas the second temperature control circuits 28 are disposed near or on the surface of the concrete ceilings, thus enabling substantially more direct cooling of the room.

In order that flow is permitted exclusively in the second temperature control circuits 28 using only one and the same pipe arrangement, the changeover valve 42 is first switched over, that is, transferred to the second setting thereof, such that the first connection pipe 44 connects the connection end 14 of the feed pipe 12 to the return end segment 24 of the return pipe 20. The second connection pipe 46 simultaneously connects the feed end segment 16 of the feed pipe 12 to the connection end 22 of the return pipe 20. Flow is thus permitted in the feed and return end segments 16, 24 in the opposite direction to the first operating mode. It must thereby be ensured that the temperature control medium exiting the second temperature control circuits 28 cannot flow into the two first temperature control circuits 26. This is achieved in turn in that the second check valve 40 is now operated in its flow direction, while the first check valve 38 prevents a flow of the temperature control medium from the branch-off points 34 of the second temperature control circuits 28 to the branch-off points 30 of the first temperature control circuits 26.

As previously described, the pipe arrangement 10 thus has flow in different directions, depending on the operating mode (night or day mode), and relative to the feed and return end segments 16, 24 and the first and second temperature control circuits 26, 28. The temperature control medium required and flowing in each case thereby always flows in through the connection end 14 of the feed pipe 12 and out through the connection end 22 of the return pipe 20.

1. A pipe arrangement for temperature control of building, having
a feed pipe comprising a connection end for connecting to the feed of a temperature control device and comprising a feed end segment,
a return pipe comprising a connection end for connecting to the return of a temperature control device and comprising a return end segment,
at least one first temperature control circuit branching off from the feed pipe segment of the feed pipe and opening into the return end segment of the return pipe, and
at least one second temperature control circuit branching off from the feed pipe segment of the feed pipe and opening into the return end segment of the return pipe.
characterized in that
the feed end segment of the feed pipe comprises a first check valve disposed between the branch-off point of the at least one first temperature control circuit and the branch of the at least one second temperature control circuit,
the return end segment of the return pipe comprises a second check valve disposed between the opening point of the at least one first temperature control circuit and the opening point of the at least one second temperature control circuit,
a changeover valve, switchable between a first and a second setting, is disposed between the connection end of the feed pipe and the feed end segment thereof and between the return end segment of the return pipe and the connection end thereof, comprising a first connection pipe and a second connection pipe,
wherein, in the first setting of the changeover valve, (i) the first connection pipe is switched to connect between the connection end of the feed pipe and the feed end segment thereof and (ii) the second connection pipe is switched to connect between the return end segment of the return pipe and the connection end thereof, and
wherein, in the second setting of the changeover valve, (i) the first connection pipe is switched to connect between the connection end of the feed pipe and the return end segment and (ii) the second connection pipe is switched to connect between the feed end segment and the connection end of the return pipe, and
that flow is permitted through the first check valve in the flow direction thereof and the second check valve is blocked when the changeover valve is in the first setting, and the first check valve is blocked and flow is permitted through the second check valve when the changeover valve is in the second setting.

2. The pipe arrangement according to claim 1,
wherein a plurality of first temperature control circuits and a plurality of second temperature control circuits are provided, that the first check valve is disposed within the feed end segment of the feed pipe between the group of branch-off points of the plurality of first temperature control circuits and the group of branch-off points of the plurality of second temperature control circuits, and that the second check valve is disposed within the return end segment of the return pipe between the group of opening points of the plurality of first temperature control circuits and the group of opening points of the plurality of second temperature control circuits.

3. The pipe arrangement according to claim 1, wherein all first and second temperature control circuits are disposed according to a Tichelmann distribution between the feed end segment of the feed pipe and the return end segment of the return pipe.

4. The pipe arrangement according to claim 1, wherein the feed pipe, in a region between the connection end thereof and the feed end segment thereof, and the return pipe, in a region between the return end segment and the connection end thereof, cross each other at a crossing point, and that the changeover valve is disposed between the connection end of the feed pipe and the crossing point of the feed pipe and return pipe, and between the return end segment of the return pipe and the crossing point of the feed pipe and return pipe.

5. The pipe arrangement according to claim 2, wherein all first and second temperature control circuits are disposed according to a Tichelmann distribution between the feed end segment of the feed pipe and the return end segment of the return pipe.

6. The pipe arrangement according to claim 2, wherein the feed pipe, in a region between the connection end thereof and the feed end segment thereof, and the return pipe, in a region between the return end segment and the connection end thereof, cross each other at a crossing point, and that the changeover valve is disposed between the connection end of the feed pipe and the crossing point of the feed pipe and return pipe, and between the return end segment of the return pipe and the crossing point of the feed pipe and return pipe.

7. The pipe arrangement according to claim 3, wherein the feed pipe, in a region between the connection end thereof and the feed end segment thereof, and the return pipe, in a region between the return end segment and the connection end thereof, cross each other at a crossing point, and that the changeover valve is disposed between the connection end of the feed pipe and the crossing point of the feed pipe and return pipe, and between the return end segment of the return pipe and the crossing point of the feed pipe and return pipe.
